(19) United States
(12) Patent Application Publication
(10) Pub. No.: US 2009/0003577 A1
(43) Pub. Date: Jan. 1, 2009

(54) Method and apparatus for providing customized images and ring tones

(75) Inventors: Frances Mu-Fen Chin, Naperville, IL (US); Peggy Hasan, Aurora, IL (US); Huixian Song, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/823,888

(22) Filed: Jun. 29, 2007

(51) Int. Cl. H04M 3/42

(52) U.S. Cl. 379/207.13

(57) ABSTRACT

A method and apparatus which allows the mobile user to subscribe to Customized Image and Ring Tone (CIRT) service providing them access to a CIRT server to pre-define a customized image or ring tone to be played to a called party, and sends the pre-defined image or ring tone to the called party during alerting when a call is made from the mobile user is provided. The CIRT subscriber can download images or ring tones from internet web site to CIRT server, create their own via digital camera/camera phone then send them to CIRT, or choose existing ones that are available in the CIRT server. The CIRT subscriber then selects a specific image or ring tone for a specific phone number through access to the CIRT server via the Internet or a phone call. When the subscriber calls a number that is predefined with a CIRT, the call will be routed to CIRT server first and then to the called party. When the call is routed from the CIRT server to the called party, the CIRT server will allocate the predefined CIRT and send it to the called party for display/play during alerting. The subscriber also can define a default image or ring tone on the CIRT server for called numbers that are not defined or for a matching called party DN pattern.

### BACKGROUND OF THE INVENTION

This invention relates generally to telecommunication systems and, more specifically, to a method and apparatus which provides for a customized image (or ring tone) to be displayed (or played) on a called party's mobile phone. While it is particularly directed to the art of telecommunications, and will be thus described with specific reference thereto, it will be appreciated that the invention may have usefulness in other fields and applications.

By way of background, wireless communication systems are constantly evolving. System designers are continually developing greater numbers of features for both service providers as well as for the end users. Wireless phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Wallpaper is content that may be installed on mobile phones. A wallpaper is simply a graphic that is formatted to fit the screen of hand held devices, mainly cell phones. The placement of wallpaper images on the background serves to provide a decorative touch to the overall mobile phone display, and gives the user the opportunity to personalize the display of his or her mobile phones. Wallpaper images are usually included as part of the mobile phone operating system, or are added later by the user with the addition of a designated wallpaper program or other software, or by downloading images from various sources on the Internet, such as Web pages, commercial sites, or the like. Often wallpaper images are acquired based upon a particular user's personal interests or pursuits.

It is well known that cell phones, for example, may display the number and other information regarding an incoming call. This is commonly referred to as caller ID. However, users are quicker to identify a caller if an image of the caller or some other associated visual image is also displayed on the cell phone for an incoming call. Also, it may be more pleasing and entertaining for the called party, especially if the caller can choose the image and/or ring tone. Unfortunately, an efficient means of accomplishing this is not available in the art.

The known prior art provides for called party pre-defined ring tones or images to be played/displayed on the called mobile phone. The mobile phone, which is subscribed to such service and the pre-defined ring tone or image for a particular caller, will receive the pre-defined ring tone when a call comes in from that caller. However, these services do not provide the called party a customized image/ring-tone for incoming calls as pre-defined by the calling party.

Thus, the present invention contemplates a new and improved method and apparatus that resolves the above-referenced difficulties and others.

### SUMMARY OF THE INVENTION

A method and apparatus which allows the mobile user to subscribe to Customized Image and Ring Tone (CIRT) service providing them access to a CIRT server to pre-define a customized image or ring tone to be played to a called party, and sends the pre-defined image or ring tone to the called party during alerting when a call is made from the mobile user is provided. The CIRT subscriber can download images or ring tones from internet web site to CIRT server, create their own via digital camera/camera phone then send them to CIRT, or choose existing ones that are available in the CIRT server. The CIRT subscriber then selects a specific image or ring tone for a specific phone number through access to the CIRT server via the Internet or a phone call. When the subscriber calls a number that is predefined with a CIRT, the call will be routed to CIRT server first and then to the called party. When the call is routed from the CIRT server to the called party, the CIRT server will allocate the predefined CIRT and send it to the called party for display/play during alerting. The subscriber also can define a default image or ring tone on the CIRT server for called numbers that are not defined.

In one aspect of the invention a method is provided. The method comprises: storing customized image and ring tone (CIRT) data for subscribers at a CIRT server; receiving a call from a calling party to a called party at a first switching element; verifying whether the calling party has subscribed to CIRT service; routing the call to the CIRT server based on routing information for the call; the CIRT server allocating a customized image or ring tone predefined by the calling party for the called number and routing the call to the called party with the customized image or ring tone; receiving the call at a second switching element; and routing the call with the customized image or ring tone to the called party.

In another aspect of the invention an apparatus is provided. The apparatus comprises: a first switching element that stores mobile subscriber status, location, and routing information, wherein the first network element includes a first customized image and ring tone (CIRT) application processor, a first storage element operatively coupled to the first switching element that stores call routing information; a second switching element that stores mobile subscriber status, location, and routing information and that supplies a temporary location directory number, wherein the second switching element includes a second CIRT application processor, a second storage element operatively coupled to the second switching element that stores routing information; an incoming call switching element that receives incoming calls; and at least one CIRT server storing customized image and ring tone data for subscribers, the CIRT server operatively coupled to the incoming call switching element and to the first and second switching elements via a communications network.

In yet another aspect of the invention an apparatus is provided. The apparatus comprises: a customized image and ring tone (CIRT) server for storing CIRT data for subscribers and for processing CIRT requests; means for receiving a call origination from a calling party to a called party; means for verifying whether the calling party has subscribed to CIRT service and allocating CIRT for the called party; and means for routing the call with the customized image or ring tone to the called party.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a telecommunications system suitable for implementing aspects of the present invention;

FIG. 2 is a CIRT table stored in the CIRT server;

FIG. 3 is a memory layout of data stored in the CIRT server;

FIG. 4 is a flow chart of an exemplary CIRT mobile station Service Subscription method and CIRT registration procedure in its serving MSC is shown; and

FIG. 5 is a flow chart illustrating an exemplary method of providing CIRT service for a mobile station.

### DETAILED DESCRIPTION

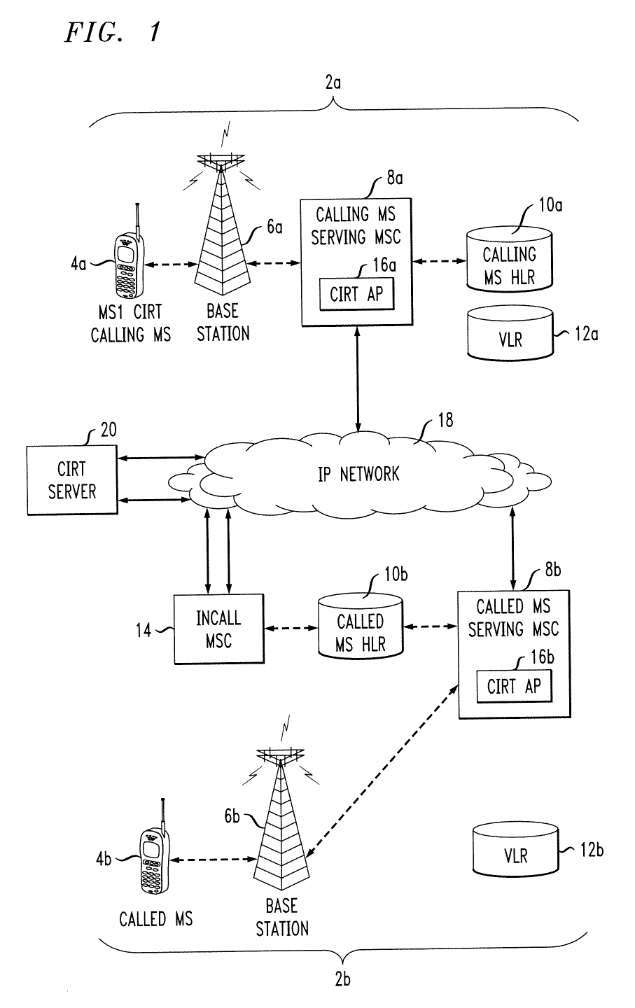

Referring now to the drawings wherein the showings are for purposes of illustrating the exemplary embodiments only and not for purposes of limiting the claimed subject matter, FIG. 1 provides a view of a system into which the presently described embodiments may be incorporated. The system may be, or may be part of, one or more of a telephone network, a local area network (“LAN”), the Internet, and a wireless network.

As shown generally, the system in FIG. 1 includes a call originating side 2a, and a call terminating side 2b. Depending on which component originates a call, the originating side 2a and the terminating side 2b may be reversed. The call originating side 2a generally includes a first mobile station (MS) 4a, a first base station (BS) 6a, a first mobile switching center (MSC) 8a, a first home location register (HLR) 10a, and a first visited location register (VLR) 12a. The terminating side 2b generally includes a second mobile station 4b, a second base station 6b, a second mobile switching center 8b, a second home location register 10b, a second visited location register 12b, and a third MSC 14. Each of the MSCs (8a, 8b) may include a special customized image and ring tone (CIRT) application processor (AP) (16a, 16b). Calls may be routed via an IP Network 18.

Finally, the system includes a CIRT server 20. The CIRT server 20 may contain CIRT data for subscribers, with respective corresponding called subscriber numbers and at least one default CIRT for use with called subscriber numbers not contained in the server. A CIRT may be associated with a prefix of a telephone number of the called subscriber numbers, an area code of a telephone number of the called subscriber numbers, and a matching pattern of a telephone number of the called party. A respective stored CIRT may be one of a user created CIRT, an image downloaded from the Internet, or a predefined CIRT.

These network entities or elements represent functional blocks or units that perform various logical functions that are implementation-independent. In other words, one or more of the above-mentioned network entities may be constructed in different physical configurations by different mobile service providers and, therefore, the model shown in FIG. 1 does not imply either a specific physical implementation of a network entity shown therein or a specific interconnection between two or more network entities shown therein.

It is therefore emphasized that the arrangement shown in FIG. 1 is for illustration only. The network entities shown in FIG. 1 may not represent actual physical connection, especially when call-routing involves many more cells and, thus, many more network entities, in a wireless network. In short, the network topology in FIG. 1 is a symbolic representation of various functional blocks comprising a wireless network and does not imply a fixed, physical implementation of those functional blocks. A service provider may choose not to provide all the network entities or all the interconnections illustrated in FIG. 1 in a given geographic area or cell. Further, more than one functional unit may be implemented on a single physical device, or, alternatively, some functional blocks may represent separate physical devices.

It is noted that the terms “mobile subscriber,” “network subscriber,” “mobile station,” and “mobile user” may be used interchangeably. The mobile stations (MS) 4a, 4b may refer to a human individual who has subscribed to one or more mobile wireless services. The term “mobile station,” as used herein, may also include a mobile service user who uses the subscribed wireless service(s) with a mobile telephone handset or with a computer equipped for wireless communication or with any other similar device. Further, “mobile communication” may include voice, data or any other information communicated via a mobile wireless network. A “mobile station” includes a wireless terminal used by the subscriber to access network services over a radio interface. The wireless terminal may comprise a portable unit (e.g., hand-held unit), a unit installed in a vehicle, or a fixed location unit. The wireless terminal is the interface equipment used to terminate the radio path at the subscriber. Although the present system and method may be used with any type of network (wired and wireless, for example), the subscriber is typically a mobile subscriber using a mobile station.

The mobile switching centers 8a, 8b are functional entities that represent automatic wireless message switching elements. An MSC may be distinguished from an MTSO (mobile telephone switching office), which may refer more to the physical architecture of the wireless switching office including switching hardware, the physical building, etc. An MSC typically provides interface for user traffic between a cellular network and other public switched networks (PSTNs) or other MSCs in the same or other networks. An MSC provides basic switching functions and coordinates the establishment of calls to and from cellular subscribers. Thus, an MSC is responsible for various call processing, as well as mobile subscriber mobility management, functions.

An MSC first receiving a call placed by a caller (calling a mobile subscriber) may be referred to as the “anchor MSC” (e.g., the first MSC 8a), whereas an MSC that finally delivers the call to a mobile subscriber (and thus completes the call) may be referred to as the “serving MSC” (e.g., the second MSC 8b). The geographic location of the mobile station at the time of call reception (from the external telephone network, e.g., the Public Switched Telephone Network (PSTN) or another wireless network) determines whether the anchor MSC and the serving MSC are the same or different.

The base stations 6a, 6b are entities that provide the means for the mobile stations to access network services using radio. Although not shown, a base station typically includes a base station controller and a base transceiver system. In this regard, the cell phone users may be connected through a base station system for placing calls. The base station system consists of base station controllers and base transceiver stations, and its primary responsibility is to transmit voice and data traffic between the mobile stations.

The wireless network may interconnect with an SS7 (Signaling System No. 7) network as a backbone network to transport IS-41 signaling messages through the telecommunications system. SS7 packets may be used to convey signaling information from an originating point to a destination point through multiple switching nodes in the mobile network, which may encompass more than one wireless network operated by one or more service providers. SS7-based transactions may query databases and invoke functions at remote points throughout the mobile wireless network to establish and maintain calls and to perform reliable call management functions. The SS7 backbone network may be owned and operated by the same service provider as the one operating the interconnected wireless network. Alternatively, a wireless service provider may join an independent SS7 network provider to accomplish desired call routing. Service control points (not shown) are special types of end signaling points in an SS7 network that perform transaction processing of remote operations.

The location registers, i.e., the HLRs 10a, 10b and the VLRs 12a, 12b, are data-based systems that assist in controlling mobile subscriber services and contain the records and stored information related to mobile subscribers of a particular mobile service provider. The location registers are queried by other network entities to obtain the current status, location, and other information to support calls to and from mobile users within the wireless network. Location registers may also contain network address translation information to assist in the routing of calls to the appropriate network destination.

An HLR is typically a primary database repository of subscriber information used to provide control and intelligence in wireless networks. The HLR thus contains records of subscriber information such as features selected by a subscriber as part of the mobile service plan, status of the subscriber (e.g., active, inactive, suspended service, etc.), the subscriber's mobile directory number (i.e., the number a calling party has to call to reach the mobile subscriber), information about the current geographic location of the mobile subscriber, etc. An HLR may be shared by more than one MSC. An HLR is generally managed by the wireless service provider company and represents the “home” database of subscribers who have subscribed for the wireless service in that home area served by the wireless service provider.

A VLR is a database that primarily maintains temporary records associated with individual network subscribers. Thus, the VLR represents a “visitor's” database for mobile subscribers who are being served in a defined local area. The VLR is also managed by a wireless service provider. However, the VLR and the HLR may be managed by the same or by different wireless service providers depending on the current geographic location of the mobile subscriber in the wireless network. The term “visitor” may refer to a mobile subscriber who is being served by one or many systems in the home service area, or an MS who is roaming in a non-home, or “visited” service area (i.e., service area of a service provider that is different from the service provider the MS has signed up with). The VLR generally contains subscriber location, status, and service features information that is derived from the relevant HLR, here, HLR. The serving MSC (8a or 8b) may access its associated VLR to retrieve information for the handling of calls to and from visiting subscribers. Similar to the HLR, the VLR may also serve one or more MSCs.

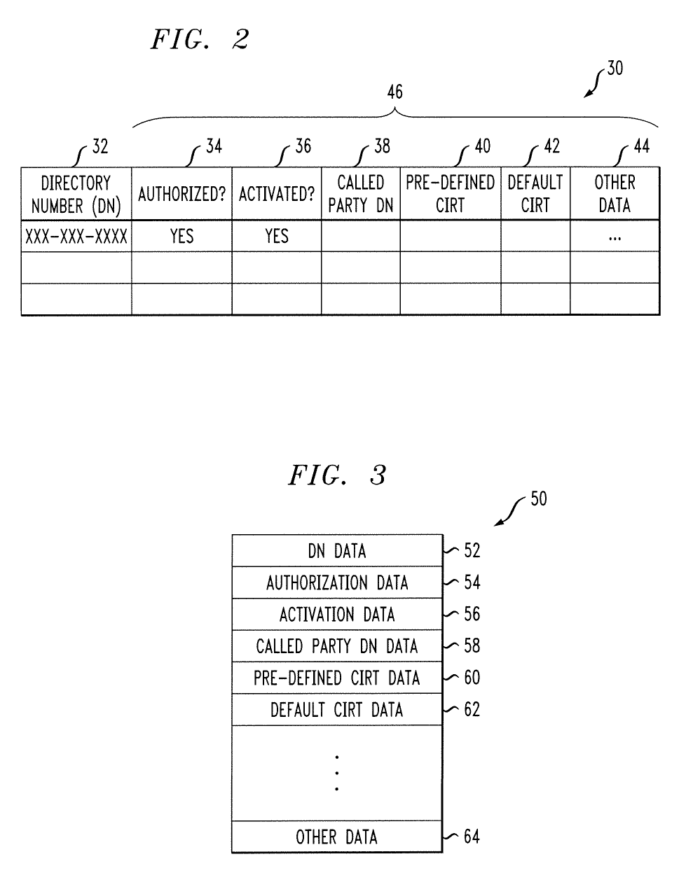

Customized image and ring tone data for subscribers may be stored in the CIRT server 20 in various configurations, such as in a CIRT table 30 as shown in FIG. 2. The table 30 includes at least one key, in this case, the directory number (DN) 32 of the subscriber or calling party (e.g., the first mobile station 4a). Thus, for each key or calling party directory number 32, there may be any number of associated fields relating to the special CIRT service feature, such as an “Authorized?” field 34, an “Activated?” field 36, at least one called party directory number field 38, at least one pre-defined CIRT field 40 for the called party directory number(s), at least one default CIRT field 42 for directory numbers not listed in CIRT server or for a matching directory number pattern (e.g., NPA+X(7 digits), and at least one additional field 44 that may be helpful to implement the invention. The “Authorized?” field 34 indicates whether the subscriber has subscribed to the special CIRT service. The “Activated?” field indicates whether the subscriber has pressed the appropriate feature activation code (e.g., *777) to activate the CIRT service. The “Activated?” field can be marked as “No” if the subscriber deactivates the CIRT service. The “Authorized?” and Activated?” fields may be only contained in the HLR and VLR records. The associated fields collectively define the CIRT service record 46 for each directory number 32.

The CIRT server 20 may store CIRT data for directory numbers in a record (or data block) 50, as shown in FIG. 3. Such a record 50 is shown as a super data block, not all of whose fields (or data sub-blocks) are filled for a particular subscriber. The super data block 50, as known in the art, can be accessed from the identity of any one of several fields (or data sub-blocks) in the super block. As shown, the super block 50 includes any number of data sub-blocks, including a first sub-block 52 that contains DN data (key), a second sub-block 54 that contains data indicating whether CIRT service is authorized for the DN, a third sub-block 56 that contains data indicating whether CIRT service for the DN is active or not (attribute), a fourth sub-block 58 that contains called party DN data, a fifth sub-block 60 that contains pre-defined CIRT data, and a sixth sub-block 62 that contains default CIRT data. Of course, it is to be understood that any number of additional sub-blocks 64 may be provided in the super block 50 for storing other data.

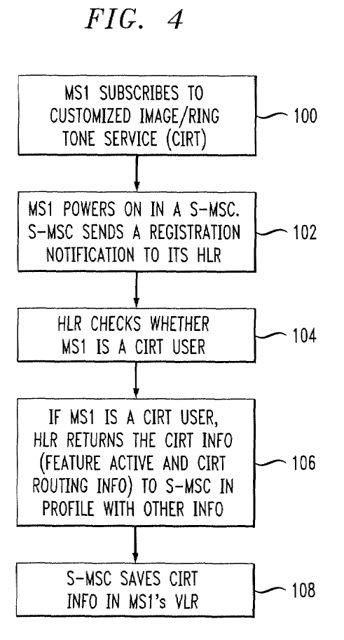

Turning now to FIG. 4, an exemplary CIRT mobile station Service Subscription method and CIRT registration procedure in its serving MSC is shown. Initially, the first MS 4a subscribes to the new CIRT service through their telecommunications service provider (100). The subscription of this service (active or inactive) and CIRT server routing address may be stored in the first HLR database 10a. Alternatively, the data may be stored in one or more other network elements. The CIRT subscriber creates his or her own customized image(s) and/or ring tone(s). This can be done by choosing the predefined image from the CIRT server 20, downloading from an Internet web site, or creating the customized image with a digital camera or camera phone and sending it to the CIRT server 20. The CIRT subscriber selects a desired image and/or ring tone for a directory number. The subscriber may optionally select a default customized image or ring tone for other numbers that are not defined in the CIRT server 20 or that matches a predefined pattern DN.

Next, the first MS 4a powers on, and the first MSC 8a sends a registration notification to its HLR 10a (102). The first HLR 10a checks whether the first MS 4a is a CIRT subscriber (104). If the first MS 4a is a CIRT subscriber, then the first HLR 10a returns the CIRT data (feature active and CIRT routing info) to the first MSC 8a in the profile with the other information (106). When the first MS 4a is registered in the first MSC 8a, its CIRT feature information and the CIRT server routing information will be passed in its profile from the first HLR 10a to the first VLR 12a (108).

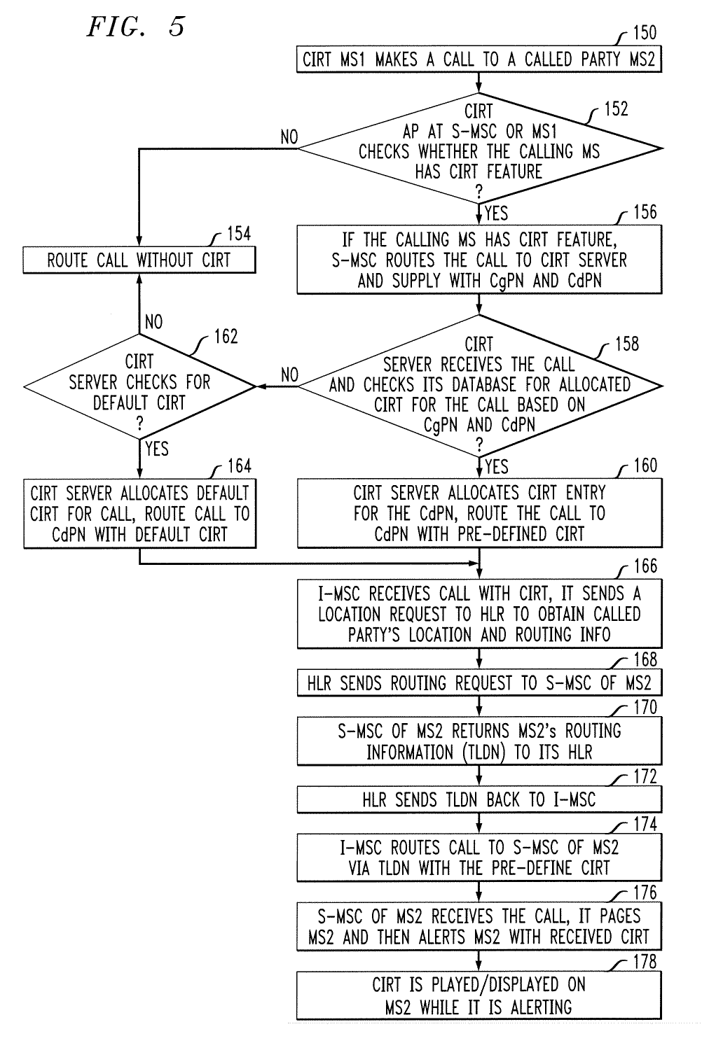

Turning now to FIG. 5, an exemplary method of providing CIRT service is shown. In this case, the first MS 4a is originating a call to a directory number with or without a pre-defined CIRT. Initially, the first MS 4a originates a call at the first MSC 8a (i.e., the serving MSC) to the second MS 4b (150). The serving MSC 8a verifies service, i.e., it checks its VLR record to determine if this calling subscriber has CIRT service or not (152). If the mobile subscriber does not have the service, the call is routed in usual manner (154). However, if the mobile subscriber has the service, the first MSC 8a routes the call to the CIRT server 20 based on the routing information and passes the calling party and called party number to the CIRT server 20 (156).

The CIRT server 20 receives the call and determines whether there is a pre-defined image or ring tone to be displayed/played for the called party (158). If the CIRT server 20 can find a CIRT entry for the called party number, the CIRT server 20 allocates the pre-defined image and/or ring tone to be displayed/played for the called party and routes the call to the called party with the pre-defined image ring tone (160). It should be noted at this point that calls to the called mobile station may arrive at a serving MSC that is not the called party's home MSC, i.e., the called mobile is roaming in a different region. Therefore, in such a case, the CIRT image and/or ring tone will be passed on from the called party's home MSC/incoming call MSC 14 to the serving MSC 8b.

If the CIRT server 20 cannot find a CIRT entry for the called party number (i.e., it is not defined for the called number), then it checks if a default CIRT is defined (162). If not, then the call is routed without a CIRT (154). If yes, the CIRT server 20 allocates the default image and/or ring tone and routes the call to the called party 4b with the default image and/or ring tone, such as his/her favorite picture or hometown landmark image (164).

The incall MSC 14 receives the call with the CIRT and sends a location request to the second HLR 10b to obtain the called party's location and routing information (166). The second HLR 10b sends a routing request to the serving MSC of the second MS 4b (i.e., the second MSC 8b) (168). The second MSC 8b returns the Routing Information (TLDN) of the second MS 4b to its HLR 10b (170). The second HLR 10b sends the TLDN back to the incall MSC 14 (172), which routes the call to the second MSC 8b via the TLDN with the pre-defined CIRT (174). The second MSC 8b receives the call, pages the second MS 4b, and alerts the second MS 4b with the received CIRT (176). The CIRT is displayed/played on the second MS 4b while it is alerting (178).

It is to be understood that in the wireless network system the called mobile also can have the similar service except the CIRT is pre-defined by the called mobile for callers. When both services are supported in the system, the calling party has a CIRT pre-selected for the called party and the called party has a CIRT selected for the same caller, then a split screen display or a sequential CIRT display approach, i.e., calling party's CIRT followed by the called party's CIRT, can be adopted.

Some portions of the above description were presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise as apparent from the preceding discussion, it is appreciated that terms such as “performing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to systems for performing the operations herein. These systems may be specially constructed for the required purposes, or they may comprise one or more general-purpose computers selectively activated or reconfigured by one or more computer programs stored in the computer(s). Such computer program(s) may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems will be apparent from the description. In addition, the present exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, and the like).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method comprising:
storing customized image and ring tone (CIRT) data for subscribers at a CIRT server;
receiving a call from a calling party to a called party at a first switching element;
verifying whether the calling party has subscribed to CIRT service;
routing the call to the CIRT server based on routing information for the call;
the CIRT server allocating a customized image or ring tone for the calling party and routing the call to the called party with the customized image or ring tone;
receiving the call at a second switching element; and
routing the call with the customized image or ring tone to the called party.

2. The method defined in claim 1, wherein the customized image or ring tone for the calling party comprises a pre-defined image or ring tone specifically designated for the calling party.

3. The method defined in claim 1, wherein the customized image or ring tone for the calling party comprises a default image or ring tone.

4. The method defined in claim 1, wherein the CIRT data comprises one or more of the following types of data: calling party directory number data, data indicating whether CIRT service is authorized for the calling party directory number, data indicating whether CIRT service for the calling party directory number is active or not, called party directory number data, pre-defined CIRT data, default CIRT data, and matching directory number pattern data.

5. The method defined in claim 1, wherein the first and second switching elements comprise mobile switching centers.

6. An apparatus comprising:
a first switching element that stores mobile subscriber status, location, and routing information, wherein the first network element includes a first customized image and ring tone (CIRT) application processor,
a first storage element operatively coupled to the first switching element that stores CIRT call routing information;
a second switching element that stores mobile subscriber status, location, and routing information and that supplies a temporary location directory number, wherein the second switching element includes a second CIRT application processor,
a second storage element operatively coupled to the second switching element that stores routing information;
an incoming call switching element that receives incoming CIRT calls and process CIRT calls; and
at least one CIRT server storing customized image and ring tone data for subscribers, the CIRT server operatively coupled to the incoming call switching element and to the first and second switching elements via a communications network.

7. The apparatus defined in claim 6, wherein the CIRT data comprises one or more of the following types of data: calling party directory number data, data indicating whether CIRT service is authorized for the calling party directory number, data indicating whether CIRT service for the calling party directory number is active or not called party directory number data, pre-defined CIRT data, default CIRT data, and matching directory number pattern data.

8. The apparatus defined in claim 6, wherein the first and second switching elements and the incoming call switching element comprise mobile switching centers and the first and second storage elements comprise home location registers.

9. The apparatus defined in claim 6, wherein the CIRT server is operative to allocate a customized image or ring tone for the calling party and route the call to the called party with the customized image or ring tone.

10. An apparatus comprising:
a customized image and ring tone (CIRT) server for storing CIRT data for subscribers and for processing CIRT requests;
means for receiving a call origination from a calling party to a called party;
means for verifying whether the calling party has subscribed to CIRT service and allocating CIRT for the called party; and
means for routing the call with the customized image or ring tone to the called party.

11. The apparatus defined in claim 10, wherein the CIRT server is operative to allocate a customized image or ring tone for the calling party and route the call to the called party with the customized image or ring tone.

12. The apparatus defined in claim 10, wherein the customized image or ring tone for the calling party comprises a pre-defined image or ring tone specifically designated for the calling party.

13. The apparatus defined in claim 10, wherein the customized image or ring tone for the calling party comprises a default image or ring tone.

14. The apparatus defined in claim 10, wherein the CIRT data comprises one or more of the following types of data: calling party directory number data, data indicating whether CIRT service is authorized for the calling party directory number, data indicating whether CIRT service for the calling party directory number is active or not called party directory number data, pre-defined CIRT data, default CIRT data, and matching directory number pattern data.
